(19) United States
(12) Patent Application Publication
(10) Pub. No.: US 2006/0066217 A1
(43) Pub. Date: Mar. 30, 2006

(54) Cathode structure for field emission device

(76) Inventor: Jong Woo Son, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/952,352

(22) Filed: Sep. 27, 2004

(51) Int. Cl. H01J 1/62

(52) U.S. Cl. 313/497

(57) ABSTRACT

To avoid arcing and shorting within a field emission device, a bottom portion of a gate electrode is protected with an insulating material to avoid or reduce arcing among the electrodes and the electron emitters in the device. In a method for manufacturing such a field emission device, an emitter hole is formed through an insulating layer such that a portion of the gate electrode overhangs the hole and is protected on its underside by the insulating layer. The device can be used in display systems, such as CNT flat panel displays.

### BACKGROUND

1. Field of the Invention

This invention relates generally to field emission devices, and in particular to cathode structures for field emission devices designed to avoid arcing and shorting among the electron emitters and the electrodes in the device.

2. Background of the Invention

Flat panel displays (FPDs) using carbon nanotube (CNT) technology are replacing and superceding existing display technologies, including those that use cathode ray tubes (CRTs), thin film transistor liquid crystals (TFT-LCDs), plasma display panels (PDPs), and organic light emitting diodes (OLEDs). The emerging CNT-based flat panel display technology uses a process for generating pictures similar to the method used in CRTs. But instead of a CRT's single hot filament electron gun, CNT-based displays use a planar array of carbon nanotube emitters as a source of electrons.

In one example, a CNT-based field emission display comprises a cathode structure disposed on a back plate and an anode structure on an opposing face plate. The cathode structure includes a matrix of row electrodes and column electrodes (either of which may be emitter or gate electrodes). Electron emitters—in this case, CNTs—are disposed within cavities or holes in the cathode structure that correspond to particular pairs of row and column electrodes. When an appropriate voltage is applied between a particular row and column electrode, electrons are emitted from the emitters corresponding to that pair of row and column electrode. These emitted electrons are accelerated towards the anode structure on the face plate by an electric field, normally created by a combination of the anode and the row and column electrodes. The anode structure includes a plurality of color elements (e.g., phosphors), each of which absorbs the energy from the emitted electrons and emits light of a particular color. This light, when combined with the light from other color elements, creates an image on the display.

The display can be matrix-addressed by applying voltages to each of its row and column electrons to control precisely the electron emission of the emitters for any particular row and column. The intersection of a row line and a column line in the matrix defines a picture element, or sub-pixel, the smallest addressable element in an electronic display. In a typical color display system, each pixel includes three picture elements corresponding to the pixel's component colors (e.g., red, green, and blue), and in a monochrome display, each pixel has a single picture element. Controlling the emission of electrons of each picture element thus controls the light intensity of each picture element and, in turn, the color of each pixel and the overall picture on the display. By matrix-addressing each picture element or pixel of the display, any desired refresh rate can be accomplished.

In the field emission display described above, each picture element has its own electron source—the set of emitters corresponding to a particular row and column electrode pair. This provides a highly redundant electron source for the display. Compared to competing technologies, CNT-based field emission displays provide pristine picture quality, robust video response, wide viewing angles, and low power consumption. This alleviates the size, weight, and power limitations of a conventional CRT, while providing higher picture quality, lower manufacturing cost, and more efficient power consumption than LCDs.

A problem arises in the design of such displays, however, due to their use of electric fields between the emitters and the other electrodes. The electric fields involved in these field emission displays can cause electrical arcing between the electrodes (e.g. the gate electrode and the emitter electrode, of the emitters thereon), which can result in serious and possibly damaging results. This arcing can be the result of sudden changes within the display, such as a change in the electrical field or in the work function of the emitters. When arcing occurs, the electrodes may be compromised. The gate electrode, for example, can be partially melted, and the hole structure in which the emitters are disposed can be severely damaged and rendered inoperable. Moreover, when forming CNTs in the emitter hole structure, it may be difficult to control their height. Because of their varying height, some CNTs can contact the gate electrode, causing an electrical short between the gate electrode and the emitter electrode (to which the CNTs are electrically coupled).

In a typical CNT field emission display, the emitter hole structure is made by etching or otherwise removing insulating material on which the gate electrode is disposed. Commonly, insulating material directly under a portion of the gate electrode is removed, which exposes the gate electrode directly to the emitters that sit inside the emitter holes. By exposing the gate electrodes to the CNT emitters that are coupled to the emitter electrodes, undesirable effects such as electrical arcing and shorting can occur. These problems are pronounced when the electrical field within the device and/or the emitters' work function suddenly changes.

### SUMMARY OF THE INVENTION

To avoid arcing and shorting within a field emission device, devices and methods are applied to shield certain electrodes in the device from the electron emitters. In one embodiment, this problem is addressed by protecting the exposed gate metal in the holes, for example by covering at least a portion of the exposed gate electrode with an insulating material.

In one embodiment, a bottom portion of the gate electrode is protected with a dielectric or other insulating material to avoid or reduce arcing from emitters to the gate electrode. This insulating material may further help to reduce or eliminate electrical shorting between the gate electrode and the emitters, which are electrically coupled to the emitter electrode. By reducing arcing, the driving of the device is made more stable, allowing the voltage applied to the gate electrode to be increased. Increasing the gate voltage increases the electron emission from the emitters, which results in a greater maximum brightness of picture elements in a display. As a result of reducing or eliminating electrical shorting, the gate leakage current is reduced. This allows for a higher anode current under the same operating conditions, which also leads to a greater maximum brightness of picture elements in a display.

In one embodiment, a method for manufacturing a field emission device comprises disposing an emitter electrode, an insulating layer, and a gate electrode. To accommodate emitters, an emitter hole is formed through the insulating layer such that a portion of the gate electrode overhangs the hole and is protected on its underside by the insulating layer. To achieve this, in one embodiment, the insulating layer comprises two or more layers of insulating material. An upper portion of the insulating layer proximate to the gate electrode is selected to have a slower etch rate, or selectivity, in wet and/or dry etching than the other material in the insulating layer. For example, the insulating layer may comprise two or more layers, where the top layer is selected to have a slower etch rate than the lower layers. By controlling material selection, the etch process, and the original thickness of the insulating layer, an emitter hole structure with a desired geometry can be achieved so that at least a portion of the underside of the gate electrode is protected.

### BRIEF DESCRIPTION OF THE DRAWINGS

FIG. 1 is a cross sectional view of a field emission device, in accordance with an embodiment of the invention.

FIGS. 2A through 2H illustrate a method for manufacturing the cathode structure of the device shown in FIG. 1, in accordance with one embodiment of the invention.

FIG. 3 is a top view of an example field emission device, such as a display system, in accordance with an embodiment of the invention.

### DETAILED DESCRIPTION OF THE PREFERRED EMBODIMENTS

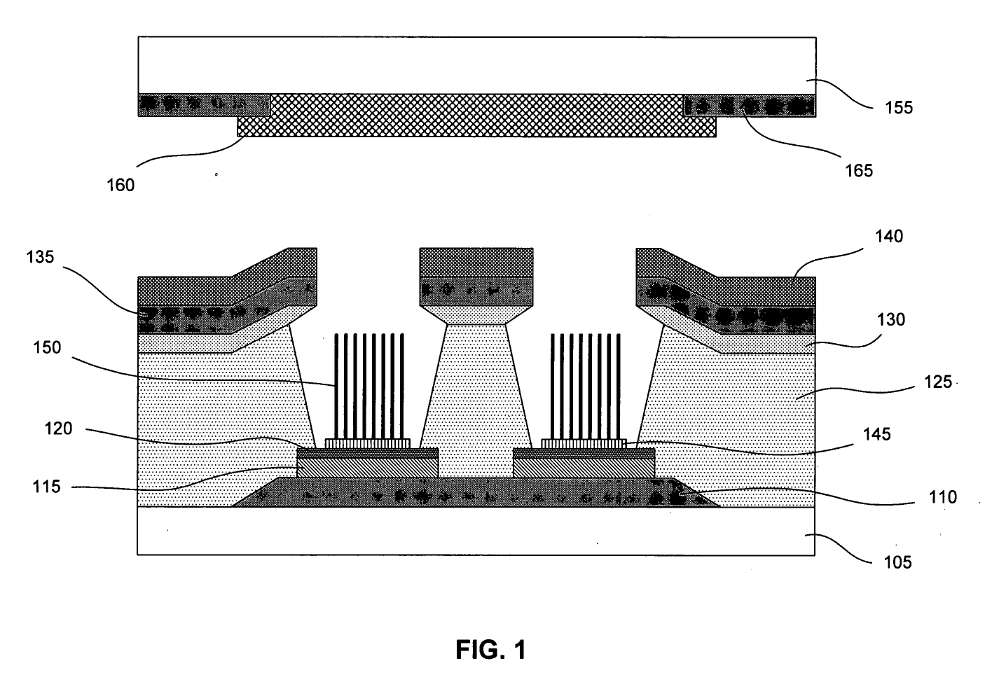

FIG. 1 illustrates one embodiment of a field emission device for emitting electrons, such as a portion of a CNT-based field emission display described above. The field emission device shown in FIG. 1 comprises two main structures: a cathode structure and an anode structure. The cathode structure includes a number of layers of material deposited over a substrate 105, such as glass. In one embodiment, the layers of the cathode structure include an emitter electrode 110, a resistor layer 115, a barrier layer 120, one or more insulating layers 125 and 130, a gate electrode 135, and a passivation layer 140. The cathode structure further comprises electron emitters 150, such as carbon nanotubes, which are situated in one or more emitter holes formed through a portion of the cathode structure. Preferably, the electron emitters 150 are disposed on or in electrical coupling with the emitter electrode 110. The electron emitters may be formed from a catalyst layer 145, which rests over the barrier layer 120.

In an embodiment in which the field emission device is to be used in a display system, the cathode structure lies opposite a corresponding anode structure, as shown. The anode structure comprises an anode 165 and a color element 160, such as a phosphor, both of which are disposed on a face plate 155. Preferably, the face plate 155 is made of a transparent material, such as glass, so that light emitted from the color element 160 can shine through the face plate 155. This enables the field emission device to generate a colored pixel of an image when the color element 160 is excited by electrons emitted from the emitters 150.

The gate electrode 135 partially overhangs the emitter hole, a cavity formed through the insulating layer 125 and 130 in which the emitters 150 are situated. In one embodiment of the invention, the insulating layer 130 covers at least some of the underside of the overhanging part of the gate electrode 135, which would otherwise be exposed directly to the emitters 150. Because the insulating layer 130 is made of an electrically insulating material, such as a dielectric, the insulating layer 130 prevents or reduces the instance of electrical arcing between the emitters 150 and the gate electrode 135 under certain operating conditions. Additionally, because the insulating layer 130 does not conduct electricity, it can prevent an electrical short that would result if an emitter 150 were to touch the underside of the gate electrode 135. In one embodiment, one or both of the insulating layers 130 and 125 comprise silicon nitride.

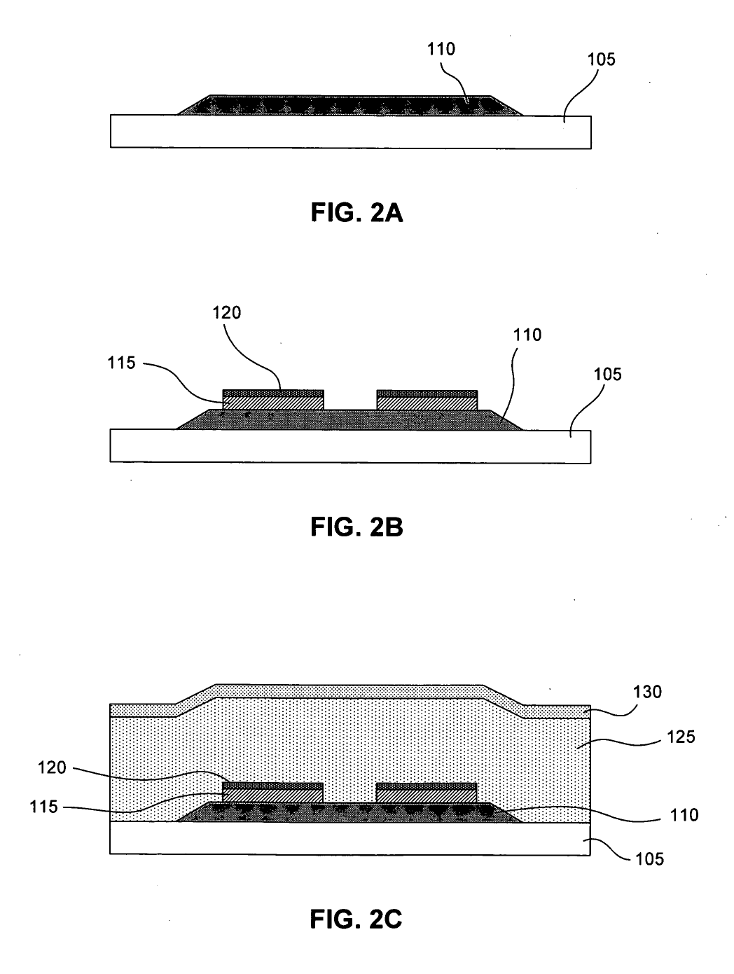

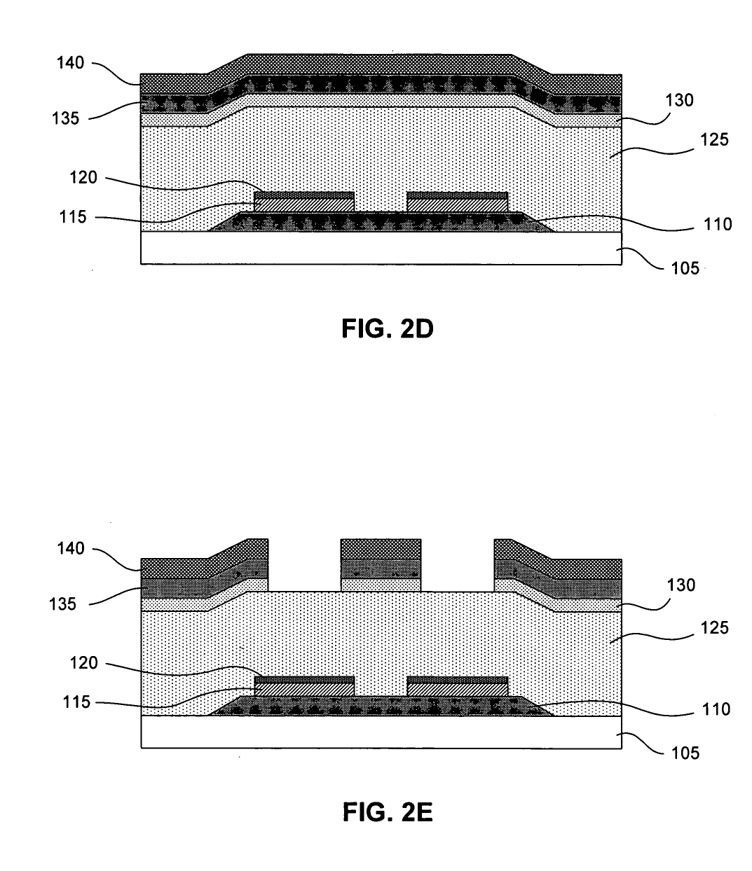

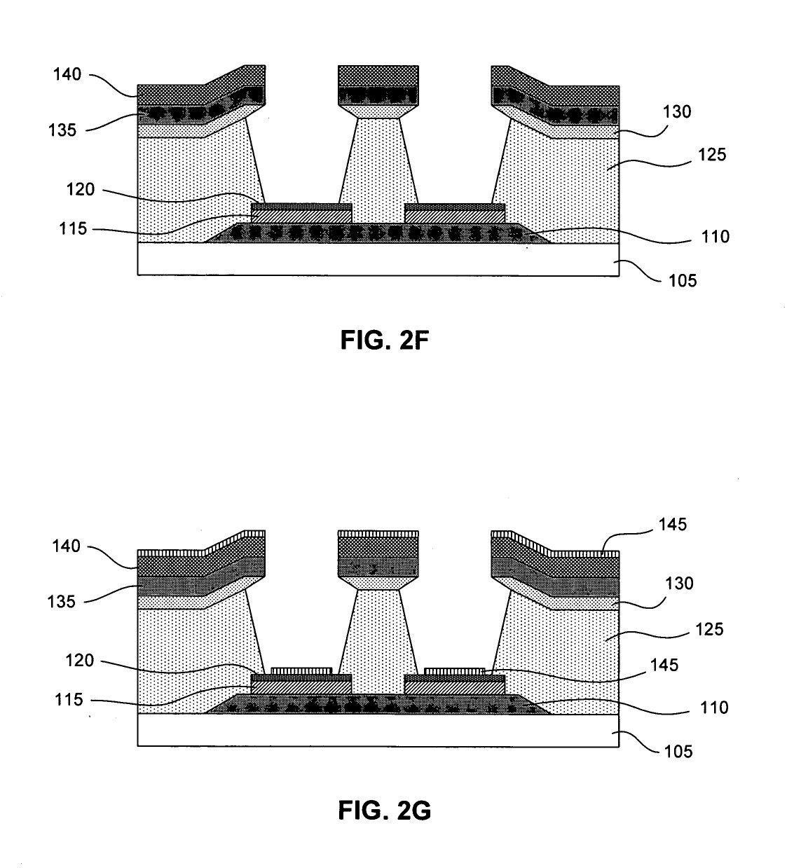

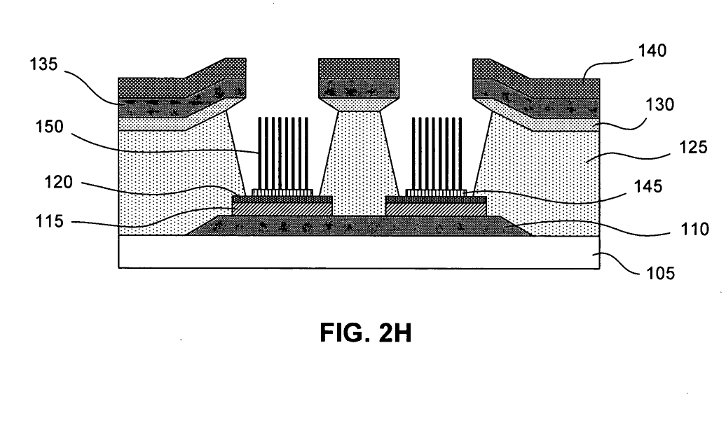

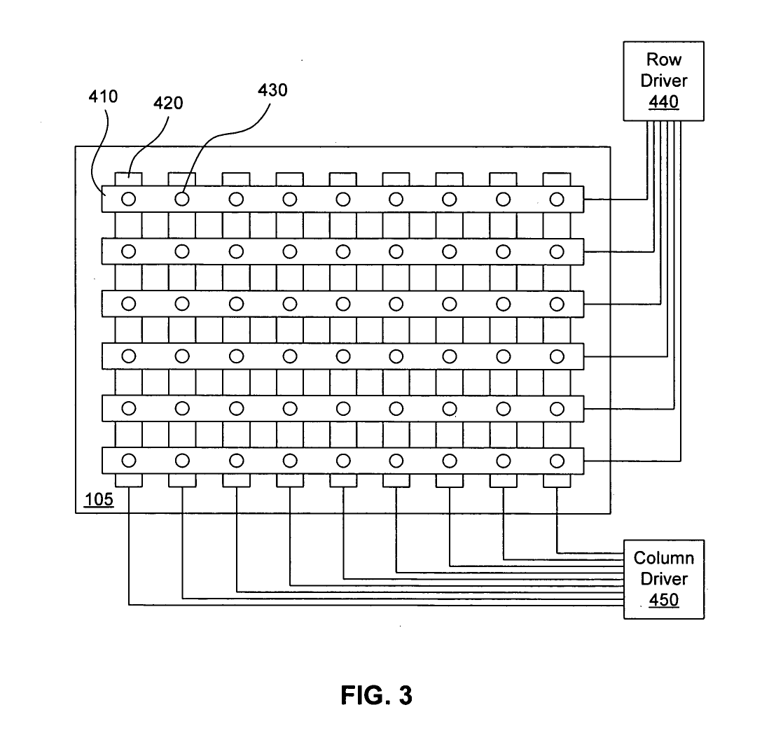

FIGS. 2A through 2H illustrate an embodiment for making a cathode structure for the device illustrated in FIG. 1. Although in a typical field emission device a number of cathode structures would be formed (e.g., for each picture element in a display system), only a single structure is illustrated in these figures. It is understood that the process described below can be repeated in a patterned across a substrate to produce a device with a plurality of cathode structures, such as the matrix-addressable device shown in FIG. 3.

As shown in FIG. 2A, an emitter electrode 110 is formed on a substrate 105. Preferably, the substrate 105 is made of glass or another electrically insulating material. The emitter electrode 110 is formed in one embodiment by depositing an electrically conductive material, such as a metal, onto the substrate 105. A precise shape and placement of the emitter electrode 110 can be achieved by patterning the electrode 110 on the substrate 105 with a photolithography process.

Once the emitter electrode 110 is formed, a resistor layer 115 and a barrier layer 120 are formed over the emitter electrode 110. In one embodiment, a semiconductor or other resistive material (such as a-Si or doped a-Si) is deposited on the emitter electrode 110 to form the resistor layer 115. A diffusion barrier metal (such as Ti, TiW, TiN, Cr, or Mo) is then deposited over the resistor layer 115 to form the barrier layer 120. A desired pattern of the resistor layer 115 and the barrier layer 120 may be achieved by etching the layers 115 and 120. The layers 115 and 120 may be etched by dry etch or by wet and dry combination etching.

An insulating layer is then deposited on the cathode structure. In the embodiment shown in FIG. 2C, the insulating layer comprises two distinct layers 125 and 130 of insulating material. In one embodiment, the first insulating layer 125 comprises SiON and may be deposited by chemical vapor deposition (CVD). The second insulating layer 130 comprises SiNₓ and is formed over the first insulating layer 125 by a process such as CVD. Preferably, the two insulating layers 125 and 130 are chosen to have a good etch selectivity in a specific chemical or gas. In one embodiment, the layers 125 and 130 are chosen so that the etch selectivity for the first layer 125 is faster than the etch selectivity of the second layer 130 for a particular chemical or gas. For example, the etch rate of SiON is about five times faster than the etch rate of SiNₓ in BHF. As described below, selecting insulating layers 125 and 130 having an appropriate etch selectivity will achieve the desired geometry of an emitter hole, formed through these layers 125 and 130 in a later step. In one embodiment, the first and second insulating layers 125 and 130 are different materials, and each comprises an insulator selected from a group consisting of SiON, SiNₓ, and SiO₂.

The gate electrode 135 and passivation layer 140 are then formed over the insulating layers 125 and 130, as shown in FIG. 2D. The gate electrode 135 may be formed by depositing an electrically conductive material, such as a metal, onto the structure. A precise shape and placement of the gate electrode 135 can be achieved by patterning the electrode 135 on the cathode structure using a photolithography process. The passivation layer 140 is then deposited over the gate electrode 135, preferably continuously to cover the gate electrode 135. The passivation layer 140 provides electrical shielding of the top of the gate electrode 135.

Once formed, the passivation layer 140, gate electrode 135, and second insulating layer 130 are then patterned to form one or more holes therethrough (two holes shown in FIG. 2E). In one embodiment, this patterning is performed by dry and wet combination etching using a single mask pattern. Preferably, the patterned holes are arranged to form a symmetrical hole structure and correspond to the resistor layer 115 and barrier layer 120 formed over the emitter electrode 110 in previous steps. Although the second insulating layer 130, the gate electrode 135, and the passivation layer 140 need not be patterned in a single step, doing so minimizes the number of steps in the manufacturing process and thus decreases the cost of the device.

As shown in FIG. 2F, the first insulating layer 125 is etched to form one or more emitter holes therethrough. These emitter holes preferably correspond to the patterned holes formed through the second insulating layer 130, the gate electrode 135, and the passivation layer 140, formed during the step illustrated in FIG. 2E. Although only two emitter holes are illustrated, a typical field emission device can have a large number of such holes.

In one embodiment, emitter holes through the first insulation layer 125 are patterned by dry and/or wet etching. During this etching process, the second insulating layer 130 is also etched, as shown by a small amount of its material having been removed in FIG. 2F. If the second insulating layer 130 is chosen to have a higher etch selectivity than the first insulating layer 125, this second layer 130 is etched more slowly. In this way, only a relatively small amount of the material of the second insulating layer 130 is removed when the emitter hole is formed through the first insulating layer 125. Preferably, although the second insulating layer 130 becomes thinner from its bottom and inside edges during the etching process, as shown, it still covers at least a portion of the underside of the gate electrode 135. It can thus be appreciated that adjusting the properties of the insulating layers 125 and 130 as well as the other parameters of the etching process, according to known scientific principles, the amount of insulating layer 130 that remains to cover the bottom of the gate electrode 135 can be controlled. Variations in the insulating layers 125 and 130 that can be adjusted to produce a desired geometry include the thickness of each layer 125 and 130, the materials used, the dielectric material composition, and the etching methodology (including the type of etchant used).

Once the emitter holes are formed in the cathode structure, electron emitters 150 are formed within the holes. The emitter holes preferably expose either the emitter electrode 110 itself or another element electrically coupled thereto—in this case, the resistor layer 115 and barrier layer 120. In this way, emitters 150 formed in the emitter holes will also be electrically coupled to the emitter electrode 110. In one embodiment, the electron emitters comprise carbon nanotubes 150.

FIGS. 2G and 2H illustrate one method for forming carbon nanotube emitters 150 within the emitter holes. First, a catalyst layer 145 is laid deposited over the cathode structure. The catalyst layer 145 can be granularized, e.g., through the application of heat, to provide a seed layer on which carbon nanotubes can more easily be formed. Unwanted portions of the catalyst layer 145, such as portions of the layer 145 not within the emitter holes, can be removed through etching or any other suitable process. As shown in FIG. 2H, carbon nanotube emitters 150 are then formed within the emitter holes. In one embodiment, the carbon nanotube emitters 150 are grown using plasma enhanced chemical vapor deposition (PECVD).

Although various embodiments for forming the cathode structure for a field emission device have been described and illustrated, it can be appreciated that any number of variations can be made to these while achieving the benefit of protecting the gate electrode to avoid electrical arcing and shorting. Specific details of steps in various processes for producing a cathode structure suitable for a field emission device (such as a display system) can be found in the following, each of which is incorporated by reference in its entirety: U.S. application Ser. No. 10/080,057, filed Feb. 20, 2002; U.S. application Ser. No. 10/080,012, filed Feb. 20, 2002; U.S. application Ser. No. 10/302,126, filed Nov. 22, 2002; U.S. application Ser. No. 10/327,529, filed Dec. 20, 2002; U.S. application Ser. No. 10/600,226, filed Jun. 19, 2003; U.S. application Ser. No. 10/807,485, filed Mar. 27, 2004; and U.S. Provisional Application No. 60/563,075, filed Apr. 15, 2004.

Embodiments of the field emission devices can be used in display systems, such as matrix-addressable CNT-based field emission display. For example, the device illustrated in FIG. 1 may be a part of a display system in which electrons are emitted and accelerated towards an anode structure containing color elements (e.g., phosphors). The structure shown in FIG. 1 typically corresponds to a single picture element, or subpixel, of the display. A number of groups of emitters, comprising for example carbon nanotubes, are situated within corresponding emitter holes, or cavities, in the cathode structure. Each of the groups of emitters for a given picture element are indexed by an emitter electrode and gate electrode, which typically run perpendicular in a matrix-addressable display system. Although only two groups of emitters and cavities are illustrated, a typical display includes a large number of emitter holes (e.g., tens or hundreds) for each picture element.

FIG. 3 shows a top view of the back plate and cathode structure of one embodiment of such a display system. For simplicity, not all layers of the cathode structure are illustrated. The back plate includes a plurality of row electrodes 410 and column electrodes 420, with sets of electrons emitters situated in emitter holes 430. As shown in FIG. 3, the row electrodes 410 are gate electrodes column electrodes 420 are emitter electrodes; however, these may be reversed in other embodiments. In essence, the back plate structure comprises a plurality of field emission devices, such as those described above, in a matrix arrangement on the back plate of the display. In the display system, each pair of a row electrode 410 and a column electrode 420 indexes a single picture element of the display.

The emitters associated with a picture element can be made to emit electrons (toward an anode on a face plate structure, not shown) through appropriate driving of the row driver 440 and column driver 450, which are coupled to the row electrodes 410 and column electrodes 420, respectively. When an appropriate voltage is applied between a particular row and column electrode 410 and 420, electrons are emitted from the emitters corresponding to that pair of row and column electrode 410 and 420. In this way, the display is matrix-addressable to control precisely the electron emission of the emitters for each row and column. The emitted electrons are accelerated towards an anode structure on the face plate by an electric field. The anode structure includes a plurality of color elements (e.g., phosphors), which absorb the energy from the emitted electrons and emit light of a particular color. In a typical color display system, each pixel includes three picture elements corresponding to the pixel's component colors (e.g., red, green, and blue). Controlling the emission of electrons of each picture element thus controls the light intensity of each picture element and, in turn, the color of each pixel and the overall picture on the display.

As used herein, the terms situated over and formed over, as well as any similar terms applied to layers, are not meant to limit the structure such that the layers must necessarily be directly over one another or that the layers must be in physical contact. Where one layer is over another layer, in any sense, there may exist other layers between those layers. Moreover, two layers need not be coextensive, or even overlap, for one layer to be over the other. These terms thus refer to the layers' respective ordering in various embodiments of the devices described herein, and should be understood in the broad context of the disclosure.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. For example, the insulator layer may be a single material, more than two layers of distinct materials, or a material with continuously varying properties. Moreover, additional layers may be used, layers may be eliminated, and the layers may be ordered differently. It is therefore intended that the scope of the invention be limited not by this detailed description, but rather by the claims appended hereto.

What is claimed is:

1. An electron-emitting device comprising:
an emitter electrode;
an insulating layer disposed over the emitter electrode, the insulating layer having an emitter hole formed therethrough;
a plurality of electron emitters electrically coupled to the emitter electrode and situated within the emitter hole; and
a gate electrode disposed over the insulating layer and overhanging the emitter hole, where at least a portion of an overhanging underside of the gate layer is electrically insulated from the electron emitters.

2. The device of claim 1, wherein at least a portion of the overhanging underside of the gate layer is covered by the insulating layer.

3. The device of claim 1, wherein the insulating layer comprises a first insulating layer and a second insulating layer disposed over the first insulating layer.

4. The device of claim 3, wherein the first insulating layer comprises SiON and the second insulating layer comprises SiNₓ.

5. The device of claim 3, wherein the first insulating layer comprises SiNₓ and the second insulating layer comprises SiON.

6. The device of claim 3, wherein the first and second insulating layers each comprise a different insulator selected from a group consisting of: SiON, SiNₓ, and SiO₂

7. The device of claim 3, wherein the gate electrode is disposed directly over the second insulating layer, the second insulating layer covering at least a portion of the overhanging underside of the gate layer.

8. The device of claim 1, wherein a plurality of emitter holes are formed through the insulating layer, and electron emitters are situated in each emitter hole.

9. The device of claim 1, wherein the electron emitters are carbon nanotubes.

10. The device of claim 1, further comprising:
a passivation layer disposed over the gate electrode, the passivation layer electrically insulating a top side of the gate electrode.

11. An electron-emitting device comprising:
an emitter electrode;
a plurality of electron emitters electrically coupled to the emitter electrode;
a gate electrode disposed over the emitter electrode in proximity to the electron emitters; and
means for electrically insulating at least a portion of the gate electrode from the electron emitters to reduce electrical arcing and shorting therebetween.

12. The device of claim 11, wherein the means for electrically insulating comprises a plurality of insulating layers.

13. The device of claim 11, wherein the electron emitters are carbon nanotubes.

14. A display system comprising a matrix of pixels, each pixel having one or more picture elements, and for each picture element of each pixel the display system comprises:
a color element that emits light when excited by electrons; and
the electron-emitting device of any one of the previous claims, the electron-emitting device configured to emit electrons towards the color element, thereby causing the color element to emit light.

15. A method for forming a field emission device, comprising:
forming an emitter electrode on a substrate;
forming an insulating layer over the emitter electrode;
forming a gate electrode over the insulating layer; and
forming at least one emitter hole through the insulating layer so that the gate electrode overhangs the emitter hole, where at least a portion of an overhanging underside of the gate layer is electrically insulated from the electron emitters.

16. The method of claim 15, wherein the insulating layer comprises a first insulating layer and a second insulating layer disposed over the first insulating layer.

17. The method of claim 16, wherein the first insulating layer comprises SiON and the second insulating layer comprises SiNₓ.

18. The method of claim 16, wherein the first insulating layer comprises SiNₓ and the second insulating layer comprises SiON.

19. The method of claim 16, wherein the first and second insulating layers each comprise a different insulator selected from a group consisting of: SiON, SiNₓ, and SiO₂

20. The method of claim 15, wherein the second insulating layer is chosen to have a higher etch selectivity than the first insulating layer.

21. The method of claim 20, wherein forming the emitter hole comprises etching the insulating layer, where the etching leaves a portion of the second insulating layer covering at least a portion of the overhanging underside of the gate layer.

22. The method of claim 15, further comprising:
forming a plurality of emitters in the emitter hole, the emitters electrically coupled to the emitter electrode.

23. The method of claim 22, wherein the emitters are carbon nanotubes.

24. The method of claim 15, further comprising:
forming a passivation layer over the gate electrode, the passivation layer electrically insulating a top side of the gate electrode.
